(19) United States
(12) Patent Application Publication
(10) Pub. No.: US 2010/0321854 A1
(43) Pub. Date: Dec. 23, 2010

(54) ELECTROSTATIC DISCHARGE (ESD) PROTECTION METHOD AND STRUCTURE FOR ELECTRONIC PRODUCT

(75) Inventors: Jyun-Da Lin, Yonghe City (TW); Ching-Feng Hsieh, Taipei (TW)

Correspondence Address: EDWARDS ANGELL PALMER & DODGE LLP, P.O. BOX 55874, BOSTON, MA, 02205, US

(73) Assignee: ASKEY COMPUTER CORPORATION, Taipei (TW)

(21) Appl. No.: 12/550,518

(22) Filed: Aug. 31, 2009

(30) Foreign Application Priority Data
Jun. 22, 2009 (TW) 098120791

(51) Int. Cl. H05F 3/00

(52) U.S. Cl. 361/220

(57) ABSTRACT

An electrostatic discharge (ESD) protection method and structure for an electronic product internally equipped with an electronic component are provided for protecting the electronic component against electrostatic discharge. A casing of the electronic product has a through-hole corresponding in position to the electronic component and communicating with the outside. The length and shape of the through-hole are defined such that they are equal to or greater in length than the length of an electric arc produced as a result of electrostatic discharge, so as to prevent electric arcs from reaching the electronic component, thereby dispensing with an electrostatic discharge protection circuit or related component and reducing manufacturing costs of electronic products.

### BACKGROUND OF THE INVENTION

1. Field of the Invention

This invention relates to electrostatic discharge protection techniques, and more particularly, to an electrostatic discharge protection method and an electrostatic discharge protection structure for an electronic product.

2. Description of Related Art

Electronic products, such as mobile phones, notebook computers, digital processors, MP3 players and pen recorders, are becoming more and more popular. Such electronic products are compact in size, have a variety of powerful functions, and are becoming indispensable communication tools in daily life. Such electronic products have a casing and a plurality of circuit boards, and the circuit boards are stacked in parallel in the casing.

However, in daily use, these electronic products are likely to come into contact with the human body or other materials, leading to the production of electrostatic discharge (ESD). An electric arc produced as a result of the electrostatic discharge may interfere with the operation of the electronic products or even damage the electronic products. In particular, for an electronic product that has a casing provided with a through-hole, an electric arc produced as a result of the electrostatic discharge passing through the through-hole can cause damage to electrostatic discharge sensitive devices (ESDSD) under the through-hole. In order to protect such a device from this kind of damage, electronic product manufacturers provide a variety of protection designs for the devices. In general, electrostatic discharge protection means include grounding the electrostatic discharge and installing a blocking circuit. For the audio signal input/output ports of a hand-held electronic product, an ESD protection circuit is installed in a connection line of the audio signal input/output ports to block or release electrostatic energy, so as to protect the electronic product against electrostatic discharge. Further, the finished electronic product will undergo an electrostatic discharge test to determine its ESD protection capability. In practice, a manufacture or tester sets the output energy of an electrostatic discharge gun used to conduct the test according to the specifications of the country in which the electronic product is to be sold, moves the electrostatic discharge gun near or against the casing of the electronic product to release the electrostatic discharge, and determine the test results by examining whether an electric arc produced as a result of the electrostatic discharge has caused damage to any electronic components in the through-hole.

In general, the above-mentioned electrostatic discharge protection circuit installs a resistive component, an inductive component or a filter transformer on an input/output route for audio signals to block the penetration of electrostatic discharge to the electronic components. Naturally, the additional installation of the electrostatic discharge protection components increases the manufacturing costs of the electronic product. Moreover, the design goals for modern electronic products include powerful functionality and compact size, which makes it desirable to reduce the number of electronic components installed in the limited space available. Accordingly, the additional installation of electrostatic discharge protection components increases the difficulty in designing such electronic products. Even if such electronic products adopt a grounding means to release the electrostatic discharge, the capability of releasing the electrostatic discharge via the grounding means is severely degraded due to the reduced size of these electronic products, thus such electrostatic discharge protection is less than optimal.

Therefore, developing an electrostatic discharge protection method together with an electrostatic discharge protection structure that avoid the above-mentioned drawbacks is an important issue in the art.

### SUMMARY OF THE INVENTION

In view of the above-mentioned problems of the prior art, the present invention provides an electrostatic discharge protection method and an electrostatic discharge protection structure for an electronic product that allow a designer to design an electrostatic discharge protection device without any additional electrostatic discharge protection circuits and related components, thereby reducing the manufacturing costs of the electronic product. When applied to a compact electronic product, the electrostatic discharge protection method and the electrostatic discharge protection structure can reduce the difficulty in designing for the limited space of the electronic product.

Accordingly, the present invention provides an electrostatic discharge protection method, which is applied to an electronic product internally provided with an electronic component, for protecting the electronic component against electrostatic discharge, the electronic product having a casing provided with a through-hole corresponding in position to the electronic component and communicating with the outside, the electrostatic discharge protection method including: determining the length of an electric arc produced as a result of the electrostatic discharge; and defining the length and shape of the through-hole according to the length of the electric arc, and forming on the casing the through-hole that is not less in length than the length of the electric arc, so as to prevent the electric arc from reaching the electronic component.

The present invention further provides an electrostatic discharge protection structure for an electronic product internally equipped with an electronic component, for protecting the electronic component against electrostatic discharge, the electronic product having a casing provided with a through-hole corresponding in position to the electronic component and communicating with the outside, characterized in that the length and shape of the through-hole are defined according to the length of an electric arc produced as a result of the electrostatic discharge, the through-hole being not less in length than the length of the electric arc, so as to prevent the electric arc from reaching the electronic component.

In one embodiment, the above-mentioned through-hole has an oblique line structure. In another embodiment, the through-hole may be designed to have a curved line, a continuous bended (stair-like) line or an irregular structure.

The above-mentioned electronic component is selected according to the electronic product to which the electronic component is applied, including any component that is installed in the through-hole of the casing that is likely to be damaged by external electrostatic discharge, such as an electrostatic discharge sensitive device such as a speaker, a microphone, a light-emitting diode, a humidity sensitive device or an IC device.

Therefore, an electrostatic discharge protection method and an electrostatic discharge protection structure for an electronic product according to the present invention are designed to have a through-hole that is formed in a casing of the electronic product and has a length greater than or equal to the length of an electric arc produced as a result of the electrostatic discharge. The present invention allows a designer to design an electrostatic discharge protection device without any additional electrostatic discharge protection circuits and related components, thereby reducing the manufacturing costs of the electronic product and the difficulty of designing the electrostatic discharge protection structure. As such, the present invention can be applied to overcome the problems of the prior art.

### BRIEF DESCRIPTION OF DRAWINGS

The invention can be more fully understood by reading the following detailed description of the preferred embodiments, with reference made to the accompanying drawings, wherein:

FIG. 1 is a cross-sectional diagram of an electrostatic discharge protection structure of an embodiment according to the present invention;

FIG. 2 is a cross-sectional diagram of an electrostatic discharge protection structure of another embodiment according to the present invention; and

FIGS. 3(A) and 3(B) are cross-sectional diagrams of a through-hole of an electrostatic discharge protection structure of other embodiments according to the present invention.

### DETAILED DESCRIPTION OF PREFERRED EMBODIMENTS

The following illustrative embodiments are provided to illustrate the disclosure of the present invention, these and other advantages and effects being readily understandable by those in the art after reading the disclosure of this specification. The present invention can also be performed or applied by differing embodiments. The details of the specification may be on the basis of different points and applications, and numerous modifications and variations can be devised without departing from the spirit of the present invention.

The present invention provides an electrostatic discharge protection method for an electronic product internally equipped with an electronic component, for protecting the electronic component against electrostatic discharge. In an embodiment of the present invention, the electronic product (not shown) is a mobile phone, a notebook computer, a digital processor, an MP3 player or a pen recorder.

The electronic product has an electronic component and a casing that covers the electronic component. The casing is provided with a through-hole. In an embodiment of the present invention, the electronic component is an electrostatic discharge sensitive device, such as, but not limited to, a speaker, a microphone, a light-emitting diode, a humidity sensitive device, or an IC, that is easily damaged by the electrostatic discharge. In an embodiment of the present invention, the through-hole is a sound conduction hole, a screw hole or a heat conduction hole.

In the embodiment, a product is exemplified to illustrate an electrostatic discharge test. An electrostatic carrier generates electrostatic discharge, and releases an electric arc. The electrostatic discharge can also be produced as a result of the friction of human body with other materials, particularly in a dry environment. Accordingly, the electrostatic carrier may be, but is not limited to, the human body, or the materials. The length of the electric arc produced as a result of the electrostatic discharge is proportional to the energy of the electrostatic carrier. In other words, the greater the electrostatic carrier is, the longer the length of the electric arc becomes.

In practice, the length and shape of the through-hole are defined according to the length of the electric arc, and the length of the through-hole is greater than or equal to the length of the electric arc produced as a result of the electrostatic discharge. When the electric arc enters the through-hole of the casing, since the length of the through-hole is greater than or equal to the length of the electric arc, the electric arc energy produced as a result of the electrostatic discharge cannot reach the electronic component, thus protecting the electronic component from damage.

In an embodiment of the present invention, the through-hole may be formed by performing on the casing an etching technique, a punching technique, an injection molding technique, a cast molding technique, or other techniques that can form the through-hole. The shape of the through-hole is in the form of an oblique line, a curved line, a continuous bended (stair-step) line or an irregular structure, such as an L-shaped structure, an N-shaped structure, an S-shaped structure, a U-shaped structure, a V-shaped structure, or a Z-shaped structure.

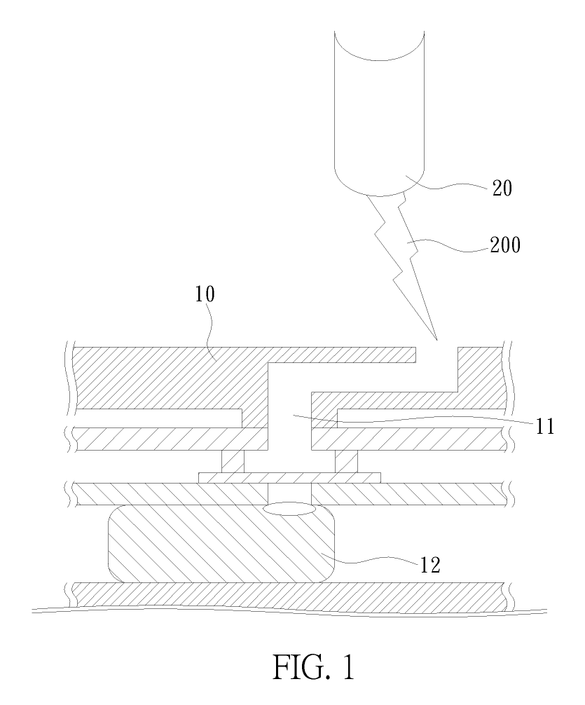

FIG. 1 is a cross-sectional diagram of an electrostatic discharge protection structure for an electronic product of an embodiment according to the present invention. FIG. 1 only shows the components that relate to the present invention, and the components are not illustrated according to the number, shape and size of the components in practice. In other words, the components of the present invention may have any number, type and size ratio and even more complicated layouts in practice.

As shown in FIG. 1, the present invention provides an electrostatic discharge protection structure for an electronic product. In an embodiment of the present invention, the electronic product (not shown) is a mobile phone, a notebook computer, a digital processor, an MP3 player or a pen recorder. The electronic product has an electronic component 12 and a casing 10 that covers the electronic component 12. The casing 10 at least has a through-hole 11. The length and shape of the through-hole 11 are defined according to the length of an electric arc produced as a result of the electrostatic discharge. In an embodiment of the present invention, the electronic component 12 is an electrostatic discharge sensitive device, such as, but not limited to, a speaker, a microphone, a light-emitting diode, a humidity sensitive device or an IC device. In an embodiment of the present invention, the through-hole 11 is a sound conduction hole, a screw hole or a heat conduction hole.

As shown in FIG. 1, an electrostatic carrier 20 generates electrostatic discharge and releases an electric arc 200. Since the length of the electric arc 200 produced as a result of the electrostatic discharge is proportional to the energy of the electrostatic carrier 20, the greater the energy of the electrostatic carrier 20, the longer the electric arc 200 produced as a result of the electrostatic discharge.

As shown in FIG. 1, the through-hole 11 is formed in the casing of the electronic product and corresponding in position to the electronic component 12, and communicates with the outside. By design, the length of the through-hole 11 is greater than or equal to the length of the electric arc produced as a result of the electrostatic discharge. If the electric arc 200 enters the through-hole 11 of the casing 10, the electric arc energy produced as a result of the electrostatic discharge cannot reach the electronic component 12 since the length of the through-hole 11 is greater than the length of the electric arc 200 produced as a result of the electrostatic discharge, thus protecting the electronic component 12 from damage. In the situation that the length of the through-hole 11 is equal to the length of the electric arc 200 produced as a result of the electrostatic discharge, since the casing 10 is not attached to the electronic component 12 directly and the through-hole 11 has some space left at both openings on the inner and outer sides of the casing 10, the electric arc produced as a result of the electrostatic discharge cannot reach the electronic component 12.

In an embodiment of the present invention, the casing may be performed with an etching technique, a punching technique, an injection molding technique, or a cast molding technique, to form the through-hole 11 that penetrates the casing 10. The openings of the through-hole 11 on both the inner and outer sides of the casing 10 are dislocated. Therefore, even if the casing 10 is thin, the through-hole 11 provided in the casing 10 can still have enough length due to the oblique angle, curvature or other shape of the through-hole 11 penetrating the casing 10. Accordingly, the through-hole 11 has an oblique line structure or a continuous bended (stair-step) line structure. Since the length of the through-hole 11 is greater than or equal to the length of the electric arc produced as a result of the electrostatic discharge, the electrostatic discharge will not intrude into the electronic component.

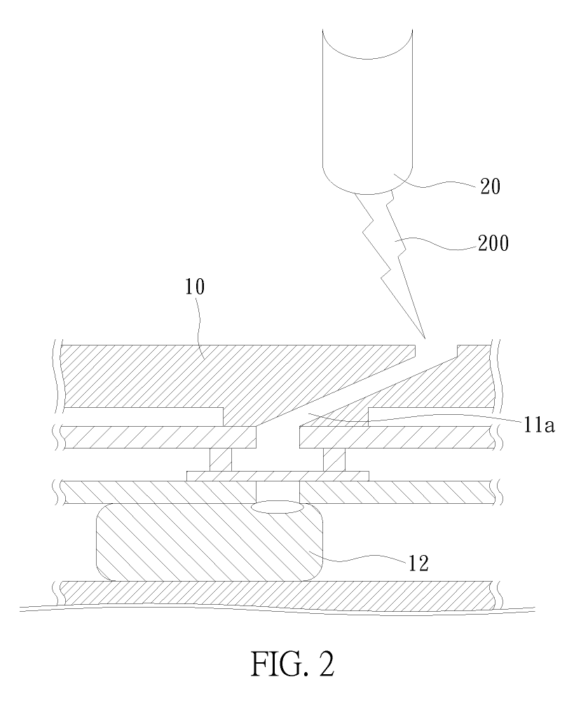

FIG. 1 portrays a through-hole 11 with a Z-shaped bended line structure. FIG. 2 portrays a through-hole 11a with an oblique line structure. In other embodiments of the present invention, the through-hole 11a may have an L-shaped structure, an N-shaped structure, an S-shaped structure, a U-shaped structure or a V-shaped structure.

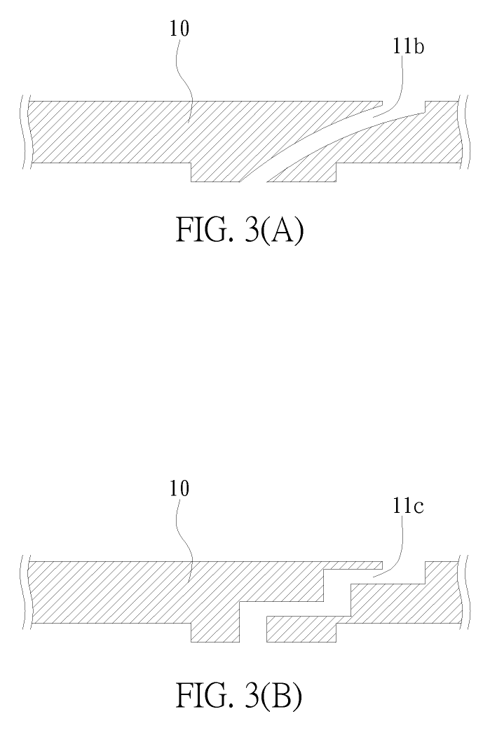

FIGS. 3(A) and 3(B) are cross-sectional diagrams of a through-hole of an electrostatic discharge protection structure of an embodiment according to the present invention. FIG. 3(A) portrays a through-hole 11b having a curved line structure, and FIG. 3(B) portrays a through-hole 11c having a continuous bended (stair-step) line structure. The present invention does not limit the through-hole to have the curved line structure or the continuous bended line structure only, further illustration being hereby omitted. Any through-hole can be applied to the present invention, as long its length is greater than or equal to the length of the electric arc produced as a result of the electrostatic discharge.

Note that since the energy of the electrostatic carrier 20 is in direct proportion to the length of the electric arc 200, the length of the through-hole is defined and designed according to the strength of the electrostatic discharge. In other words, the greater the energy of the electrostatic discharge is, the longer the length of the through-hole becomes.

Therefore, according to an electrostatic discharge protection method and an electrostatic discharge protection structure for an electronic product, a through-hole is formed in a casing of the electronic product and has a length greater than or equal to the length of an electric arc produced as a result of the electrostatic discharge, thus preventing the electrostatic discharge from reaching an electronic component provided in the electronic product. The present invention allows a designer to design an electrostatic discharge protection device without any additional electrostatic discharge protection circuits and related components, thereby reducing the manufacturing costs of the electronic product and the difficulty in designing the electrostatic discharge protection structure. Accordingly, the present invention can be applied to overcome the problems of the prior art, and is highly applicable to industry.

The foregoing descriptions of the detailed embodiments are illustrated to disclose the features and functions of the present invention and not intended to be restrictive of the scope of the present invention. It should be understood by those in the art that many modifications and variations can be made according to the spirit and principles in the disclosure of the present invention and still fall within the scope of the appended claims.

What is claimed is:

1. An electrostatic discharge protection method for an electronic product internally equipped with an electronic component, for protecting the electronic component against electrostatic discharge, the electronic product having a casing provided with a through-hole corresponding in position to the electronic component and communicating with the outside, the electrostatic discharge protection method comprising:
determining the length of an electric arc produced as a result of the electrostatic discharge; and
defining the length and shape of the through-hole according to the length of the electric arc, and forming on the casing the through-hole that is not less in length than the length of the electric, so as to prevent the electric arc from reaching the electronic component.

2. The electrostatic discharge protection method of claim 1, wherein the shape of the through-hole is in the form of an oblique line, a curved line, a continuous bended line or an irregular structure.

3. The electrostatic discharge protection method of claim 1, wherein the electronic component is an electrostatic discharge sensitive device.

4. The electrostatic discharge protection method of claim 3, wherein the electrostatic discharge sensitive device is a speaker, a microphone, a light-emitting diode, a humidity sensitive device, or an IC device.

5. The electrostatic discharge protection method of claim 1, wherein forming the through-hole is performed by an etching technique, a punching technique, an injection molding technique, or a cast molding technique.

6. An electronic discharge protection structure for an electronic product internally equipped with an electronic component, for protecting the electronic component against electrostatic discharge, the electronic product having a casing provided with a through-hole corresponding in position to the electronic component and communicating with the outside, characterized in that the length and shape of the through-hole are defined according to the length of an electric arc produced as a result of the electrostatic discharge, the through-hole being not less in length than the length of the electric arc, so as to prevent the electric arc from reaching the electronic component.

7. The electronic discharge protection structure of claim 6, wherein the shape of the through-hole is in the form of an oblique line, a curved line, a continuous bended line or an irregular structure.

8. The electrostatic discharge protection structure of claim 6, wherein the electronic component is an electrostatic discharge sensitive device.

9. The electrostatic discharge protection structure of claim 8, wherein the electrostatic discharge device is a speaker, a microphone, a light-emitting diode, a humidity sensitive device, or an IC device.
